(19) United States
(12) Patent Application Publication
(10) Pub. No.: US 2011/0264667 A1
(43) Pub. Date: Oct. 27, 2011

(54) COLUMN-ORIENTED STORAGE IN A ROW-ORIENTED DATABASE MANAGEMENT SYSTEM

(76) Inventors: Stavros HARIZOPOULOS, San Francisco, CA (US); Alkiviadis Simitsis, Santa Clara, CA (US)

(21) Appl. No.: 12/768,088

(22) Filed: Apr. 27, 2010

(51) Int. Cl. G06F 17/30

(52) U.S. Cl. 707/743; 707/741; 707/E17.085

(57) ABSTRACT

Systems, methods, and computer-readable storage media are provided for column-oriented storage in a row-oriented database management system. Data may be provided in one or more columns, each datum associated with a position within a column. A list may be created of one or more records per column, each record including a plurality of values stored in an order of position within the column and a first positional indicator. An index may be created to access a value stored in a record, wherein the index includes an index parameter derived from each record in the list and the index parameters are ordered in accordance with an order of records in the list.

### BACKGROUND

A database management system (DBMS) may be row-oriented, in which records (i.e. tuples) including data of different attributes, and therefore of different data columns, are stored contiguously. Alternatively, a DBMS may be column-oriented, in which data of the same attribute, and belonging to the same column, are stored contiguously. Column-oriented database management systems may outperform row-oriented systems on read-intensive tasks, such as business intelligence, customer relationship management, and other data warehousing tasks. Such queries typically involve searching within a subset of the attributes of the database. Because a column-oriented system may accommodate reading only the subset of columns relevant to a given query, read-intensive performance may be improved in a column-oriented system over a row-oriented system, which generally reads entire tuples (i.e. including data of all attributes) into memory.

Column-oriented DBMSs may have additional advantages over row-oriented systems. Because column data are stored contiguously in column-oriented systems, and because such data may exhibit less entropy than data from different columns, higher data compression rates may be achieved in column-oriented systems than in row-oriented systems. Furthermore, a column-oriented DBMS may operate directly on a set of compressed column data, which may avoid multiple compression/decompression cycles, and thereby reduce processing overhead.

Despite the advantages of column-oriented systems for read-intensive operations, a substantial installed base of row-oriented systems exists, and row-oriented DBMSs remain popular. In part, this may be due to the costs and risks organizations face in transitioning their database infrastructure to a new platform. Additionally, implementation of a new DBMS within an organization may require extensive customization and necessitate significant user training.

### BRIEF DESCRIPTION OF THE DRAWINGS

FIG. 1 depicts data represented logically as a matrix of rows and columns;

FIG. 2 depicts an example method of storing and searching column-oriented values in a row-oriented DBMS, according to an embodiment of the invention;

FIG. 3 depicts a list of ColumnTuples that may be used for storing column-oriented values within a row-based DBMS, in accordance with an embodiment of the invention;

FIG. 4 depicts mapping of the logically represented data from FIG. 1 into the ColumnTuple structure depicted in FIG. 3, in accordance with an embodiment of the invention;

FIG. 5A is a detailed view of a body of a ColumnTuple similar to those shown in FIG. 3, the body employing a storage scheme accommodating storage of values of equal length, in accordance with an embodiment of the invention;

FIG. 5B is a detailed view of a body of a ColumnTuple similar to those shown in FIG. 3, the body employing a storage scheme accommodating storage of values of unequal length with a slotted array pointing to the location of each value, in accordance with an embodiment of the invention;

FIG. 5C is a detailed view of a body of a ColumnTuple similar to those shown in FIG. 3, the body employing a storage scheme accommodating storage of values with a dictionary including a table of data and the corresponding value for each datum, in accordance with an embodiment of the invention;

FIG. 6 depicts a sparse value index and a positional index of a single attribute, and their relationship to ColumnTuples of that attribute in accordance with an embodiment of the invention;

FIG. 7 depicts an example system for storing column-oriented data in a row-oriented DBMS, according to an embodiment of the invention.

### DETAILED DESCRIPTION

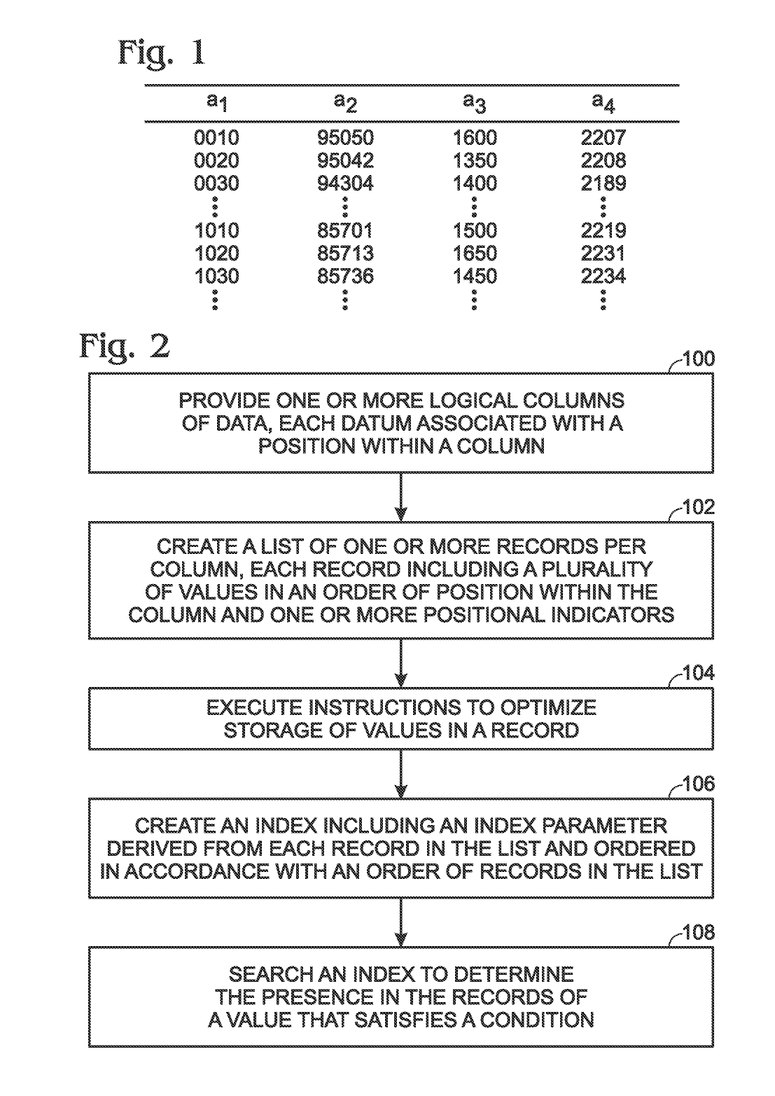

The present teachings relate to storing column-oriented data in a row-oriented database management system (DBMS). Regardless of physical storage configuration, information stored in a database may be represented in a logical matrix, an example of which is shown in FIG. 1. Each “row” of the matrix in FIG. 1 may represent information of a single entity, while each “column” may represent information of a single attribute. For example, a row in FIG. 1 may represent various information associated with a particular employee, while a column may represent information of a single attribute (e.g. attribute a1) for all employees, such as employee number. Generally, a DBMS stores information, such as the matrix in FIG. 1, as a list of records, or tuples.

Row-oriented data, as used herein, generally refers to data wherein values corresponding to a logical “row” of data, and therefore of different attributes, are stored contiguously within one or more records in physical storage (i.e. in memory, on disk, etc.), followed by records corresponding to other “rows” of data. Column-oriented data, as used herein, generally refers to data wherein the values corresponding to a particular attribute are stored contiguously within one or more records in physical storage, followed by data corresponding to other particular attributes (or “columns” of data). Because read-intensive tasks, such as determining the average salary of employees at a certain location, may involve querying only a subset of attributes, storage of data in a column-oriented format may allow more direct access to the relevant attributes, and may therefore improve DBMS performance for such tasks.

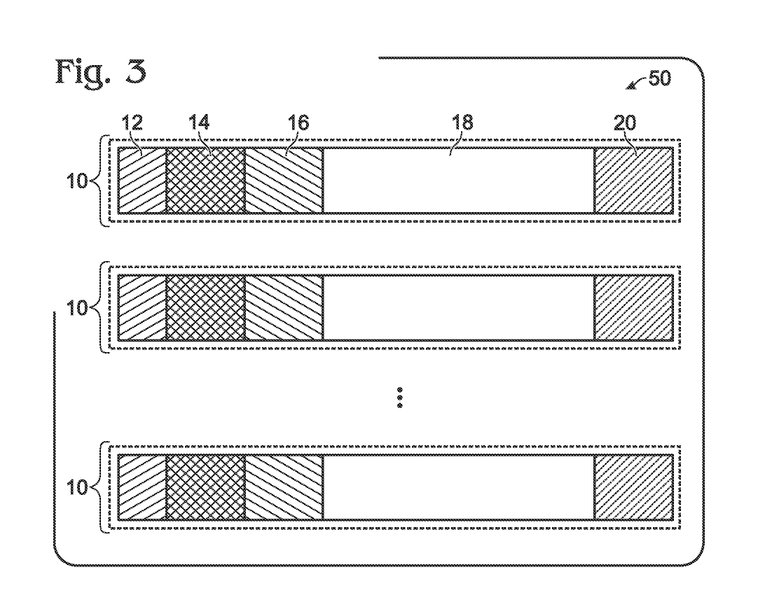

FIG. 2 depicts an example method of storing and searching column-oriented data in a row-oriented DBMS. Although the steps are shown in a particular sequence, it should be understood that these steps may be performed in other sequences, with steps being rearranged and/or performed simultaneously in some cases. In step 100, one or more logical columns of data, each datum associated with a position in a column, are provided to the DBMS.

In step 102, a list of one or more records is created per column of data provided in step 100. Each record, or ColumnTuple, includes a plurality of values in an order of position within the column (i.e. column-oriented data), and additionally includes one or more positional indicators that indicate positional information for the values in the ColumnTuple. In accordance with our teachings, it will be understood that the data of a particular attribute previously stored in a plurality of non-contiguous physical locations are now stored as values within a single-record ColumnTuple in a row-oriented DBMS.

FIG. 3 depicts a list of ColumnTuples with an exemplary storage scheme forming a part of database page 50. As indicated, each ColumnTuple 10 includes a body 18 for storing values corresponding to data of a single attribute (for example, data found in a single column of the logical matrix shown in FIG. 1). Each ColumnTuple may additionally include a header 12, a starting positional indicator 14, a numerical positional indicator 16, and an attribute indicator 20. The header 12 may include descriptive information about the tuple, e.g. the tuple ID. The starting positional indicator 14 and numerical positional indicator 16 may include positional information about the column-oriented values stored within body 18. For example, starting positional indicator 14 may indicate the position in the logical column corresponding to the first value in ColumnTuple 10, and numerical positional indicator 16 may indicate the total number of values stored in the ColumnTuple 10. Attribute indicator 20 may indicate attribute information about the values stored in ColumnTuple 10.

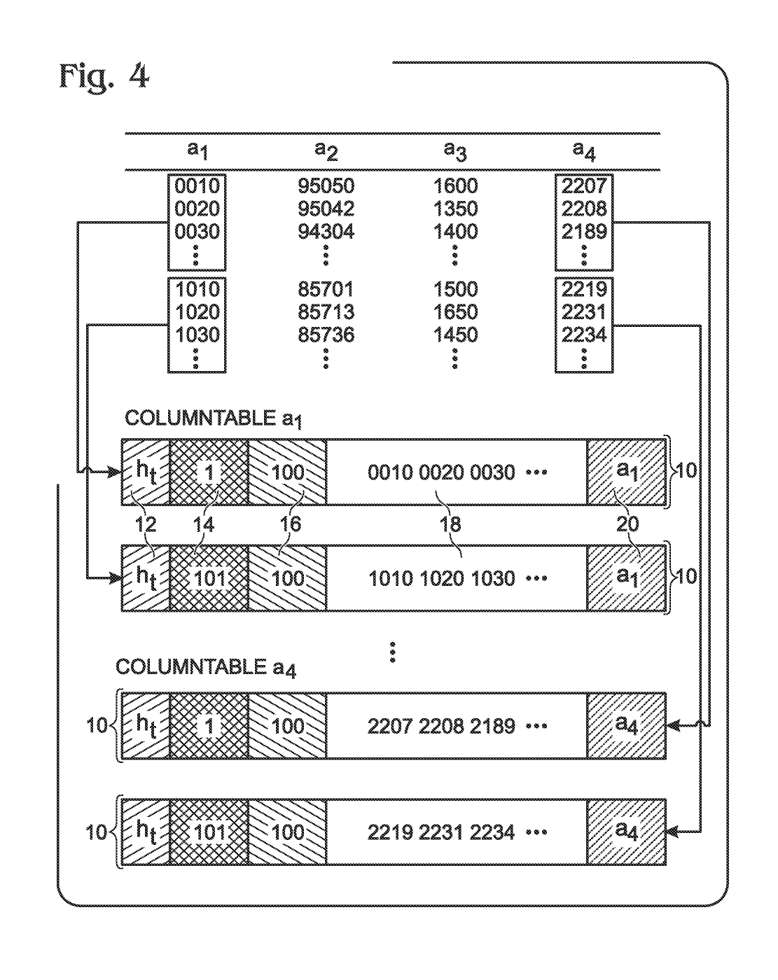

As described above, a list of one or more ColumnTuples per attribute is created in step 102 of FIG. 2. FIG. 4 demonstrates the mapping of logical columns of data onto the storage scheme shown in FIG. 3. It will be noted that data represented in the logical matrix may be mapped onto one or more ColumnTuples 10 per logical column, with values stored in order of column position in the body 18 of a ColumnTuple 10. In some embodiments, and as described in more detail below, values may be stored using an optimization algorithm within the body.

A set of one or more ColumnTuples that includes values corresponding to all data of a selected attribute may be termed a ColumnTable. For example, FIG. 4 shows ColumnTable a1, which includes the set of ColumnTuples storing all data from column a1 of the logical matrix, and ColumnTable a4, which includes the set of ColumnTuples storing all data from column a4 of the logical matrix.

In FIG. 4, starting positional indicator 14 of each ColumnTuple 10 indicates the position within the relevant column of the logical matrix corresponding to the first value within body 18. Numerical positional indicator 16 within ColumnTuple 10 indicates the total number of values stored within body 18. According to this example, and as depicted in FIG. 4, the first ColumnTuple of ColumnTable a1 includes a starting positional indicator of 1 and a numerical positional indicator of 100, indicating that the body of this ColumnTuple includes 100 values, corresponding to the data in positions 1 through 100 of logical column a1. Likewise, the second ColumnTuple of ColumnTable a1 includes a starting positional indicator of 101 and a numerical positional indicator of 100, indicating that the body of this ColumnTuple includes 100 values, corresponding to the data in column positions 101 through 200 of column a1. Thus, the relationship between the position of a value within body 18 and the corresponding datum's position within a logical column may be determined by reference to starting positional indicator 14. For example, the value “1030” in FIG. 4 is in the third position in the body of a ColumnTuple with a starting positional indicator equal to 101. Accordingly, the value “1030” corresponds to a datum in position 103 of column a1, because the first and second values in the body correspond to data 101 and 102 of column a1 respectively.

The exemplary storage scheme depicted in FIGS. 3 and 4 may be utilized to store column-sequenced values in a row-based DBMS using existing DBMS functionality. For example, a row-oriented record in a row-based DBMS would include four values representing the information in the first row of the logical matrix of FIG. 1 (i.e. 0010, 95050, 1600, and 2207), stored contiguously as four integer fields of the record. In comparison, and with reference to FIG. 4, a column-oriented ColumnTuple in the row-based DBMS may include four fields: starting positional indicator 14, numerical positional indicator 16, body 18, and attribute indicator 20. While starting positional indicator 14, numerical positional indicator 16, and attribute indicator 20 may be stored as integer fields in the ColumnTuple, body 18 may be stored e.g. as a binary object field. Thus, although body 18 of the ColumnTuple includes column-oriented values, from the point of view of the row-based DBMS a ColumnTuple may be created and stored as a row-oriented record would be.

Furthermore, this storage scheme may be implemented with a relatively small per-value overhead. Within body 18, values may be stored in an array within the binary object, and may not require additional per-value overhead for record placement, deletion, etc. Additionally, because positional information for each value may be determined by reference to starting positional indicator 14 and numerical positional indicator 16 regardless of the quantity of values stored in a body, overhead per value decreases with increasing body size. Accordingly, a ColumnTuple with more values in body 18 generally has lower per-value overhead than a ColumnTuple with fewer values stored in body 18. However, body length may be set so that each database page 50 in FIG. 3 includes any number of ColumnTuples. The number of ColumnTuples per page may be selected such that values within ColumnTuples in page 50 may be efficiently updated using all preexisting DBMS facilities for free space management, tuple allocation, etc.

Referring again to FIG. 2, and with reference to step 104, instructions may be executed to optimize storage of values in a ColumnTuple. As described above, body 18 of each ColumnTuple 10 includes values corresponding to data of a particular column in a logical matrix representation of the database. Because data of a single column may exhibit low entropy (e.g. a limited set of part numbers or states of residence), a high degree of compression may be supported within body 18 of ColumnTuple 10. Values also may be stored in body 18 without compression.

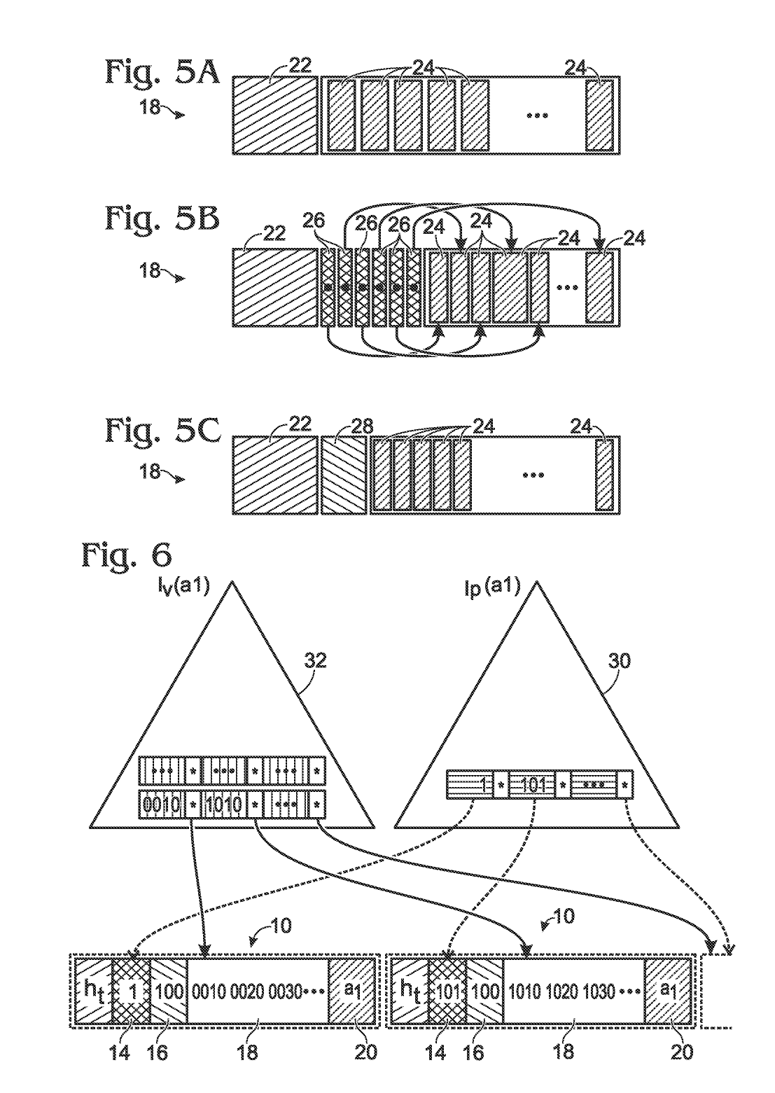

FIGS. 5A, 5B, and 5C illustrate three exemplary schemes for storing values in body 18. With reference to FIGS. 5A, 5B, and 5C, body 18 may include information contained within a segment 22, the information being suitable to provide for execution of instructions which may load values 24 into body 18, access values stored in body 18, and convert between data from a logical column and values 24 stored in body 18 according to an optimization algorithm.

FIG. 5A illustrates a storage scheme wherein each value 24 is of equal length, for example, an integer of four bytes. To determine the location of a particular value in body 18 in this exemplary storage scheme, segment 22 may include information suitable to provide for execution of instructions to multiply the ordinal position within body 18 of the value by the length of each value 24 (e.g. four bytes). Value 24 may be directly reported to the DBMS, or, alternatively, an optimization algorithm may be applied to convert value 24 before reporting (e.g. run-length encoding decompression).

FIG. 5B illustrates an exemplary storage scheme where values 24 of variable length are stored, and segment 22 may include information suitable to provide for execution of instructions to access a particular value by reference to a slotted array 26. Array 26 contains a pointer to the location of each value 24 in body 18. Segment 22 may additionally include information suitable to provide for execution of instructions to apply a decompression algorithm to value 24 as described above.

FIG. 5C illustrates an exemplary storage scheme where body 18 includes a dictionary 28, and dictionary 28 includes a table of data that may appear in the logical column, and the corresponding value for each datum. A body including dictionary 28 may reduce storage space required, for example, where the logical column includes a limited set of possible data entries (e.g. a pre-defined list of job titles) that may be represented within body 18 as a smaller character string (e.g. a two-digit code). In this exemplary scheme, value 24 may be accessed by executing instructions to retrieve a value in body 18 according to a method described previously, or an alternative method, and converting the value to its corresponding datum by reference to dictionary 28.

In a row-based DBMS, indices may be used to access data stored within the database. When column-oriented data is stored in ColumnTuples, and with reference to step 106 of FIG. 2, an index may be created including an index parameter derived from each ColumnTuple in the list, and ordered in accordance with an order of ColumnTuples in the list. Because column-oriented data may be stored in ColumnTuples within a row-oriented DBMS as described above, row-oriented DBMS functionality may be used to build these indices.

As discussed above, a ColumnTable may be built for each attribute of a logical matrix, each ColumnTable including one or more ColumnTuples storing the data from the column and one or more associated positional indicators. As depicted in FIG. 6, a positional index 30 may be built for a ColumnTable by retrieving an index parameter including positional information (e.g. starting positional indicator 14) from each ColumnTuple in the ColumnTable, and ordering the retrieved index parameters in accordance with an order of ColumnTuples in the ColumnTable. In SQL, for example, if the starting positional indicator is defined as “pos” and the ColumnTable for attribute a1 as “Ta1”, a positional index Ip(a1) may be created with the command CREATE INDEX Ipa1 ON Ta1 (pos). According to this example, FIG. 6 depicts positional index 30, labeled Ip(a1), which includes the starting positional indicators 14 of the first two ColumnTuples of ColumnTable Ta1 as the first two parameters of the index (i.e. 1 and 101).

Value indices may also be created using existing row-oriented DBMS functionality. Typically, the data of one attribute of a logical matrix will be sorted (e.g. attribute a1 in FIG. 1, sorted from low to high), so that a sparse value index may be built on that attribute. Similarly, a sparse value index may be built on the values stored within ColumnTuples of a ColumnTable, if the values correspond to logical column data that is sorted. In SQL, for example, a sparse value index may be created on ColumnTable a1 with the command CREATE INDEX Iva1 ON Ta1(a1). FIG. 6 depicts sparse value index 32, labeled Iv(a1), which includes the first values of the first two ColumnTuples of ColumnTable Ta1 as the first two parameters of the index (i.e. 0010 and 1010). Likewise, a full value index (i.e. a value index that includes all values stored within the ColumnTuples of a ColumnTable) may be created on values corresponding to data that is unsorted. The full value index may be created by scanning all values within the ColumnTable and extracting pairs of values and corresponding positional information. This scan may be accomplished, for example, by reference to the positions included in the ColumnTable's positional index, or by scanning a positional indicator in each ColumnTuple in the ColumnTable, or by another method.

With the creation of ColumnTuples and associated indices in accordance with our teachings, a row-oriented DBMS may be adapted to search and retrieve column-oriented values. Referring again to FIG. 2, in step 108, an index may be searched to determine the presence in one or more ColumnTuples of a value that satisfies a condition. For example, an index may be searched to determine the presence of a value equal to a user-defined parameter, or the presence of a value within a user-defined range. In the following sections, three exemplary code modifications are described which may be used to search and access values stored according to the schemes described above. For each exemplary code modification, the matrix representation in FIG. 1 is considered to include four attributes (a1, a2, a3, a4), with attribute a1 including sorted values, such that ColumnTables a1, a2, a3, and a4 have been created. In addition, position index Ip(a1) and sparse value index Iv(a1) have been created on attribute a1, and position indices Ip(a2), Ip(a3), and Ip(a4) have been created on attributes a2, a3, and a4. While the examples below refer to the search and access of values without reference to storage using an optimization algorithm, it should be understood that no further code modifications are required to accommodate data optimization. Because the optimization algorithms described above may be executed in accordance with information within the body of the ColumnTuple, a user may enter a query without regard to whether the values are stored using an optimization algorithm. For example, a user may enter a query for a particular job title without determining whether job titles, or compressed values representing job titles, are the values stored in the body.

### Example 1

### Probe of a Sorted Attribute for Presence of a Value

In a traditional row-oriented scheme, a probe for a particular value in a sorted column of the database would be answered by searching the value index for the relevant attribute, because the value either exists in a leaf of the index or it does not. However, in accordance with our teachings, because values are stored in ColumnTuples as described above, the value index may not contain all values for the relevant attribute (i.e. if the attribute is sorted and the index is a sparse value index). Therefore, an INDEX SCAN operator may be modified by the pseudo-code shown in Table 1 to adapt the operator to the ColumnTuple storage scheme and perform the query. As described above, Iv(a1) is considered to be a sparse value index including the first value of each ColumnTuple in ColumnTable a1. According to the modification shown in Table 1 below and with reference to FIG. 6, to determine the presence of a probe value in the ColumnTable, the INDEX SCAN operator searches the value index Iv(a1) for the highest value less than the probe value, follows the pointer to the associated ColumnTuple, and then scans the ColumnTuple to determine if the probe value is present.

TABLE 1
Code Modifications to Probe for the Presence
of a Value Within a Sorted Column

Input: a predicate a1 = x and the respective value index Iᵥ(a1)
Output: a value val
Begin.

| | |
|---|---|
| 1. | traverse Iᵥ(a1) and find the candidate leaf. |
| 2. | follow the pointer that points to the ColumnTuple c containing the |
| | maximum value v that is less than or equal to x; i.e. go to max(v) |
| | where v ≦ x. |
| 3. | do a sequential scan in the body of the ColumnTuple c until (a) a |
| | value u is equal to x, or (b) a value u is greater than x. |
| 4. | if 3(a) then return val = u. |
| 5. | if 3(b) then return val = null. |

End.

### Example 2

### Scan of a Single Sorted Attribute for Values Meeting a Defined Criterion

Unlike the probe for the presence of a value described in Example 1, a user may query to determine all values of sorted attribute a1 meeting a defined criterion. For example, a user may seek all duplicate values equal to a user-defined parameter, or all values within a user-defined range, or an alternative criterion that may require the reporting of multiple values. In this case, the pseudo-code described above is inappropriate and a different modification may be made. According to this example, an INDEX SCAN operator may be modified to include a buffer that is capable of storing one or more retrieved values meeting the criterion while continuing to scan for additional values meeting the criterion. The INDEX SCAN operator may scan values within one ColumnTuple (i.e. as shown in Table 2, until tuple value counter i equals numerical positional indicator c.num of the ColumnTuple), and then continue the scan on values in the next ColumnTuple. After the modified INDEX SCAN is complete, the values stored in the buffer may be returned to the next operator in a format that is compatible with the row-oriented DBMS. It should be appreciated that while the pseudo-code in Table 2 may be used for retrieval of all values within a user-defined range, x and y may be readily modified to perform other types of searches as well (e.g. if x=y, duplicate values equal to x will be returned).

TABLE 2
Code Modifications to Access Values of a Sorted
Attribute Meeting a Defined Criterion

Input: a predicate x ≦ a1 ≦ y and the respective value index Iᵥ(a1)
Output: a set of values val[.]
Begin.

| 1. | initialize a buffer B and a tuple value counter i. |
|---|---|
| 2. | traverse Iᵥ(a1) and find the candidate leaf for the value x. |
| 3. | follow the pointer that points to the ColumnTuple c containing |
| | the maximum value v that is less than or equal to x; i.e. go to |
| | max(v) where v ≦ x. |
| 4. | do a sequential scan in the body of the ColumnTuple c until a |
| | value u is greater than or equal to x, and then add u to B and |
| | i++. |
| 5. | while u < y do |

| | |
|---|---|
| 6. | while i ≦ c.num do |

| | |
|---|---|
| 7. | get next value u from c.body |
| 8. | i++ |
| 9. | add u to B |

| | |
|---|---|
| 10. | go to the next ColumnTuple c |
| 11. | initialize i |

| | |
|---|---|
| 12. | return val[.] = B. |

End.

### Example 3

### Retrieval of Values from Multiple Attributes

Additionally, a user may query to retrieve values from multiple attributes. For example, and with reference to FIG. 1, a user may search for the zip codes (e.g. a2) and salaries (e.g. a3) for employees within a certain range of employee numbers (e.g. across a range of a1). When the multiple attribute query includes the sorted attribute (here, a1), an INDEX SCAN on the sorted attribute may be performed according to the procedure in Example 2 to retrieve values of a1 that meet the defined criterion. For example, and according to the exemplary pseudo-code in Table 2, an index scan of Iv(a1) for a range of employee numbers will return the values of employee numbers within that range and their associated positions within the logical column of attribute a1. Because data within each row of the logical matrix (i.e. having the same logical column position) of FIG. 1 are associated with one employee, by knowing the position within attribute a1 for each employee in the range, zip code and salary data for the employees in the range may be retrieved from the same positions of attributes a2 and a3. Retrieval may be accomplished, for example, with a scan of positional indices Ip(a2) and Ip(a3). The values of attributes a2 and a3 may then be appended to the values of attribute a1 from the same position, for example, with a merge operator in a pipeline fashion. This record may be in a format that the row-store DBMS expects, so that the retrieval of values of multiple attributes is transparent to the system.

In addition, a user may query on multiple attributes not including a sorted attribute. For example, and with reference to FIG. 1, a user may search for all salaries (e.g. a3) within a particular zip code (e.g. when attribute a2 is equal to “95042”). In this example, an index scan of the sparse value index Iv(a1) would not be advantageous because no values of a1 are sought. If a full value index Iv(a2) has been created on the attribute a2 to be searched, an INDEX SCAN of Iv(a2) may be used to retrieve, for example, each matching zip code and associated position in the logical column, after which salary data from the same column positions may be merged with each returned zip code as described above.

However, if a full value index on a relevant attribute does not exist, a modified SEQUENTIAL SCAN operator may be used. A SEQUENTIAL SCAN operator in a row-based DBMS will scan every value of an attribute or set of attributes, returning those values that meet a defined criterion. However, in accordance with our teachings, because column-oriented values have been stored in ColumnTuples, the SEQUENTIAL SCAN operator may be modified to first probe the position index Ip(a2) to initiate a sequential scan of attribute a2. Because position index Ip(a2) includes the starting positional indicators of each ColumnTuple in ColumnTable a2, the modified SEQUENTIAL SCAN operator may scan by probing Ip(a2), following the pointer to each ColumnTuple, and then scanning values included in the body. For example, to determine all salaries within a particular zip code, the SEQUENTIAL SCAN operator would probe the position index Ip(a2), follow the pointers to each ColumnTuple of ColumnTable Ta2, and then scan each ColumnTuple for zip code values meeting the criterion. Following the SEQUENTIAL SCAN, the salaries at the same column position of each returned zip code value may be found and merged into one row-oriented record as described above.

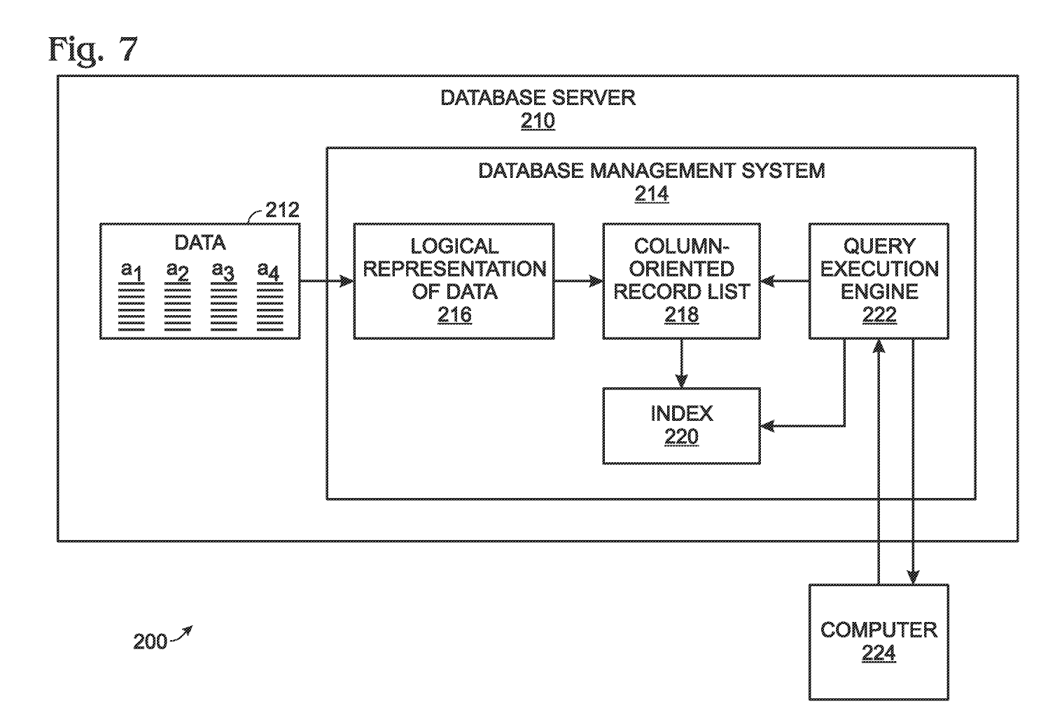

An example system for storing column-oriented data in a row-oriented DBMS is depicted in FIG. 7. Data 212 are provided to a database management system 214. In database management system 214, data 212 may be represented as logical representation 216, wherein each datum is associated with a position in a logical column. A column-oriented record list 218 (i.e. ColumnTable) of one or more records (i.e. ColumnTuples) may be created, wherein each record includes a plurality of values in an order of position within the column. Each record in list 218 may additionally include one or more positional indicators, and instructions may be executed to optimize storage of values in list 218. An index 220 including an index parameter derived from each record in list 218 may be created, wherein the index parameters are ordered in accordance with an order of records in list 218.

In the example system depicted in FIG. 7, data 212 may be searched by a user using computer 224. The computer may be a component of a database server 210, or may be connected through a network such as the internet. On entry of a query of data 212 by a user, computer 224 may send the query to query execution engine 222. Engine 222 may search index 220, and following a pointer to a record in list 218, may search a record in the list for a value satisfying the query.

We claim:

1. A method of adapting a row-oriented database management system to store and access column-oriented information, comprising:
providing data in one or more columns, each datum associated with a position within a column;
creating a list of one or more records per column, each record including a plurality of values stored in an order of position within the column, and each record further including a first positional indicator indicating positional information for the values in the record; and
creating an index to access a value stored in a record, wherein the index includes an index parameter derived from each record in the list and the index parameters are ordered in accordance with an order of records in the list.

2. The method of claim 1, each record further including a second positional indicator, and wherein the first positional indicator indicates the position in the column of the first value in the record, and the second positional indicator indicates the total number of values stored in the record.

3. The method of claim 1, wherein the index includes the first positional indicator of each record in the list, and the index is a positional index.

4. The method of claim 1, wherein the index includes the first value of each record in the list, and the index is a sparse value index.

5. The method of claim 1, wherein the index includes all values of each record in the list, the index parameters are further ordered by position within each record, and the index is a full value index.

6. The method of claim 1, further comprising:
executing instructions to store values in a record using an optimization algorithm.

7. The method of claim 6, wherein the values are of variable length and one or more records include a slotted array that indicates the location of a value in a record.

8. The method of claim 6, wherein one or more records include a table of data and the corresponding value for each datum, and the optimization algorithm converts between a datum and its corresponding value.

9. The method of claim 1, further comprising:
searching an index to determine the presence in the records of a value that satisfies a condition.

10. The method of claim 9, wherein the condition is equality of a value to a user-defined parameter.

11. The method of claim 9, wherein the condition is presence of a value within a user-defined range.

12. The method of claim 9, further comprising:
storing a value that satisfies the condition in a buffer.

13. A computer-readable storage medium having computer-executable instructions for adapting a row-oriented database management system to store and access column-oriented values, the instructions causing a computer to perform steps comprising:
reading data in one or more columns, each datum associated with a position within a column;
creating a list of one or more records per column, each record including a plurality of values stored in an order of position within the column, a first positional indicator indicating the position in the column of the first value in the record, and a second positional indicator indicating the total number of values stored within the record;
extracting an index parameter from each record in the list; and
creating an index for the list including index parameters ordered in accordance with an order of records in the list.

14. The computer-readable storage medium of claim 13, wherein the index includes the first positional indicator of each record in the list, and the index is a positional index.

15. The computer-readable storage medium of claim 13, wherein the index includes the first value of each record in the list, and the index is a sparse value index.

16. The computer-readable storage medium of claim 13, wherein the index includes all values of each record in the list, the index parameters are further ordered by position within each record, and the index is a full value index.

17. The computer-readable storage medium of claim 13, further including computer-executable instructions for:
storing values in a record using an optimization algorithm.

18. The computer-readable storage medium of claim 13, further including computer-executable instructions for:
searching an index to determine the presence in the records of a value that satisfies a condition.

19. The computer-readable storage medium of claim 13, further including computer-executable instructions for:
storing a value that satisfies the condition in a buffer.

20. A system for storing and accessing values, comprising:
data in one or more columns, each datum associated with a position within a column;
a database management system configured to:
create a list of one or more records per column, each record including a plurality of values stored in an order of position within the column, a first positional indicator indicating the position in the column of the first value in the record, and a second positional indicator indicating the total number of values stored within the record;
extract an index parameter from each record in the list; and
create an index for the list including index parameters ordered in accordance with an order of records in the list; and
a query execution engine configured to:
search an index to determine the presence in the records of a value that satisfies a condition.
